(19) United States
(12) Patent Application Publication
(10) Pub. No.: US 2018/0358804 A1
(43) Pub. Date: Dec. 13, 2018

(54) ELECTRICAL CABLES WITH INTEGRAL SURGE PROTECTION

(71) Applicant: Illinois Tool Works Inc., Glenview, IL (US)

(72) Inventors: Dimitris Jim Pelegris, Des Plaines, IL (US); Richard Joseph Urban, Prospect Heights, IL (US)

(21) Appl. No.: 16/006,411

(22) Filed: Jun. 12, 2018

Related U.S. Application Data
(60) Provisional application No. 62/519,037, filed on Jun. 13, 2017.

(51) Int. Cl. H02H 7/22; G08B 21/18

(52) U.S. Cl. CPC H02H 7/226; H01R 13/6666; G08B 21/185

(57) ABSTRACT

Electrical cables with integral surge protection are disclosed. An example electrical cable surge protector includes an electrically insulated cable; first and second plugs; and a surge protection circuit electrically coupled to be integral with the power cable with the electrically insulated cable and configured to divert surge energy conducted between the first and second plugs by the electrically insulated cable.

### RELATED APPLICATIONS

This patent application claims priority to U.S. Provisional Patent Application No. 62/519,037, filed Jun. 13, 2018, entitled “Electrical Cables with Integral Surge Protection.” The entirety of U.S. Provisional Patent Application No. 62/519,037 is incorporated herein by reference.

### TECHNICAL FIELD

The present disclosure relates generally to surge protectors and transient voltage suppressors and, more specifically, to electrical cables with integral surge protection.

### BACKGROUND

Transient voltage surge suppressors, or surge protectors, limit the amount of surge voltage a connected device experiences by diverting any voltage that measures above a designed and safe threshold. Surge protectors are designed to be plugged directly into a standard electrical outlet and then have an electrical device to be protected plugged directly into the surge protector.

Conventional surge protectors are designed for one time use and to act as an intermediate device that simply passes through electrical power to the protected electrical device. Conventional surge protectors do not adequately solve the problem of reusability. Once the surge protector diverts a threshold amount of electrical energy, the entire surge protector must be replaced to continue protection of the electrical device. Additionally, conventional surge protectors are separate, standalone devices which must act as a power bridge between the sensitive electrical device to be protected and the power supply and thus add additional circuitry and distance between the sensitive electrical device to be protected and the source of the electrical surge.

Conventional surge protectors use fuses, lights, or a combination of fuses and lights to alert the user that the surge protection circuit has been consumed and a replacement surge protector is needed. Conventional alerting techniques are commonly overlooked by most users.

### SUMMARY

Electrical cables with integral surge protection are disclosed, substantially as illustrated by and described in connection with at least one of the figures, as set forth more completely in the claims.

### BRIEF DESCRIPTION OF THE DRAWINGS

FIG. 1A illustrates an example three-conductor electrical power cord including a surge protection circuit integral with at least one plug of the electrical power cord, in accordance with aspects of this disclosure.

FIG. 1B illustrates an example three-conductor electrical power cord including a surge protection circuit integral with a cable portion of the electrical power cord, in accordance with aspects of this disclosure.

FIG. 1C illustrates an example two-conductor electrical power cord including a surge protection circuit integral with a cable portion of the electrical power cord, in accordance with aspects of this disclosure.

FIG. 1D illustrates an example AC-to-DC electrical power cord including a surge protection circuit integral with a cable portion of the electrical power cord, in accordance with aspects of this disclosure.

FIG. 1E illustrates an example audio cord including a surge protection circuit integral with a cable portion of the audio cord, in accordance with aspects of this disclosure.

FIG. 1F illustrates an example data cord including a surge protection circuit integral with a cable portion of the data cord, in accordance with aspects of this disclosure.

FIG. 2A illustrates an example system for providing communications between a surge protection circuit and an external device to provide alerts or other information, in accordance with aspects of this disclosure.

FIG. 2B illustrates an example system for providing communications between a surge protection circuit and an electronic device being protected by the surge protection circuit to provide alerts or other information, in accordance with aspects of this disclosure.

FIG. 3 is a flowchart representative of example machine readable instructions which may be executed by the surge protector cord and an unprotected device to execute a handshake protocol, in accordance with aspects of this disclosure.

FIG. 4 illustrates an example electrical cable with an integral surge protection circuit, an alert circuit, and auditory and/or visual indicators, in accordance with aspects of this disclosure.

FIG. 5 illustrates an example electrical cable surge protector with interchangeable and/or replaceable modules, in accordance with aspects of this disclosure.

The figures are not necessarily to scale. Where appropriate, similar or identical reference numbers are used to refer to similar or identical components.

### DETAILED DESCRIPTION

Surge protectors are typically more effective as the distance (e.g., electrical distance) between the surge protection circuit and the electrical device being protected decreases. For example, the further away from the desired protected device a surge protector is, the more probable that the electrical surge will experience an amplification effect due to electromagnetic coupling between the cable carrying the surge and other proximate electrical devices.

Disclosed example electrical cords include integrated surge protection circuits. Example electrical cords also include one or more plugs electrically coupled to the surge protection circuit. The surge protection circuit may be contained within any or all of the one or more plugs.

In some examples, the cords include an integrated housing that holds the surge protection circuit and couples the surge protection circuit to the conductors of the cord. The housing may be modular to enable the addition, removal, and/or replacement of modular attachments (e.g., circuits) in the housing.

The electrical cable surge protector diverts electrical surge energy to protect a device connected to the electrical cable surge protector by using a MOV (Metal Oxide Varister), or other type of surge protection circuit, to divert energy above a designated voltage threshold. Some example voltage thresholds may be between 90V and 600V for AC power systems and 12V to 1,000V for DC power systems.

Disclosed example electrical cable surge protectors comply with current power and/or data cable standards supplied by, but not limited to only, UL (Underwriter Laboratories) 1449 and IEC (International Electrotechnical Commission) C7, C13, C19, and/or other surge protection standards from other standards bodies. Furthermore, in addition to compliance with surge protection standards, disclosed examples are compliant with UL, IEC, and/or other electrical cord standards (e.g., strength, insulation, etc.).

In some examples, the electrical cable surge protector includes an alert circuit which notifies users of any potential issues and/or updates about the health or status of the electrical surge protection cable. The alert circuit may include a speaker and LED (light emitting diode) as a human interface to alert users. In other examples, the alert circuit may include a wired or wireless communication system to transmit alert information to an external device. An electrical cable surge protector may be configured to include a processor and/or a communications circuit to communicate with external devices. For example, the electrical surge protection cable can communicate with connected devices to notify the user of cable-device compatibility and/or protection status.

Disclosed examples provide a surge protection circuit integral with and/or in line with an electrical cord. Disclosed examples provide surge protection for electrical cord types include 3-prong (or 3-conductor) and/or 2-prong (or 2-conductor) AC power cords, AC-to-DC power cords, DC power cords, data cords, audio cords, and/or any other type of cord.

As used herein, the term “cord” or “electrical cord” refers to a length of one or more conductors that conduct electrical power and/or electrical signals. The one or more conductors in a cord, and/or the cord as a whole, may be insulated and/or shielded. Example cords and terminated on or more both ends by a plug. As used herein, the term “plug” refers to plugs, receptacles, and/or other types of terminations, male and/or female, that enable connection between the conductors in the cord with a device having one or more corresponding conductors of another device and/or plug.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the term “embodiments” do not require that all described embodiments include the discussed feature(s), advantage(s), or mode(s) of operation.

As used herein, the terms “communicate” and “communicating,” include both conveying data from a source to a destination and delivering data to a communications medium, system, channel, network, device, wire, cable, fiber, circuit, and/or link to be conveyed to a destination. The term “communication” as used herein means data so conveyed or delivered. The term “communications” as used herein includes one or more of a communications medium, system, channel, network, device, wire, cable, fiber, circuit, and/or link.

As used herein, the terms “coupled,” “coupled to,” and “coupled with,” each mean a relationship between or among two or more devices, apparatuses, files, circuits, elements, functions, operations, processes, programs, media, components, networks, systems, subsystems, and/or means, constituting any one or more of (i) a connection, whether direct or through one or more other devices, apparatuses, files, circuits, elements, functions, operations, processes, programs, media, components, networks, systems, subsystems, or means, (ii) a communications relationship, whether direct or through one or more other devices, apparatuses, files, circuits, elements, functions, operations, processes, programs, media, components, networks, systems, subsystems, or means, and/or (iii) a functional relationship in which the operation of any one or more devices, apparatuses, files, circuits, elements, functions, operations, processes, programs, media, components, networks, systems, subsystems, or means depends, in whole or in part, on the operation of any one or more others thereof.

As used herein, the term “data” means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” is used to represent predetermined information in one physical form, encompassing any and all representations of corresponding information in a different physical form or forms.

As used herein, the term “network” includes both networks (e.g., local networks and/or wire area networks) and inter-networks of all kinds, including the Internet, and is not limited to any particular network or inter-network.

The term “processor” as used herein means processing devices, apparatuses, programs, circuits, components, systems, and subsystems, whether implemented in hardware, tangibly embodied software, and/or tangibly embodied firmware. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

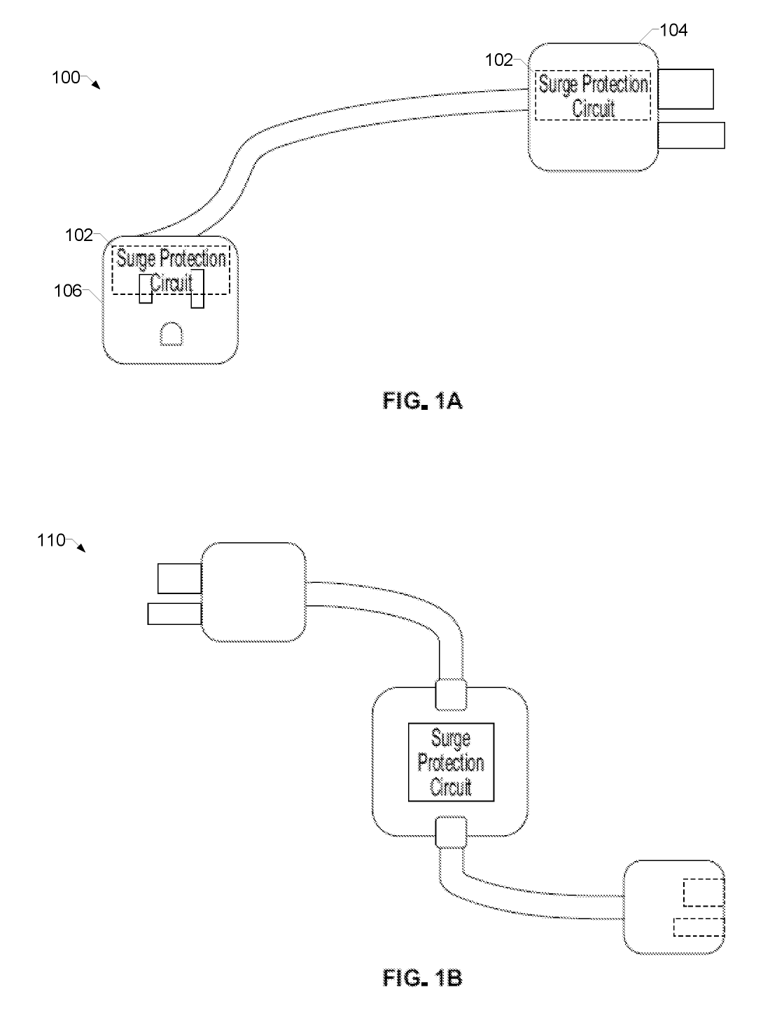

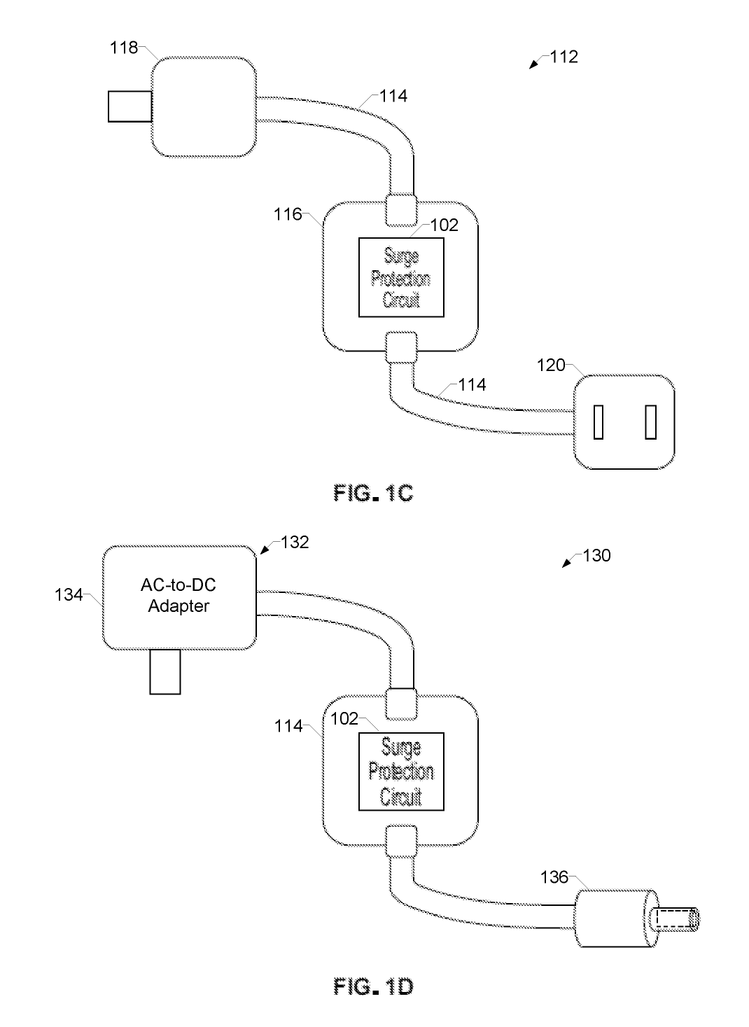

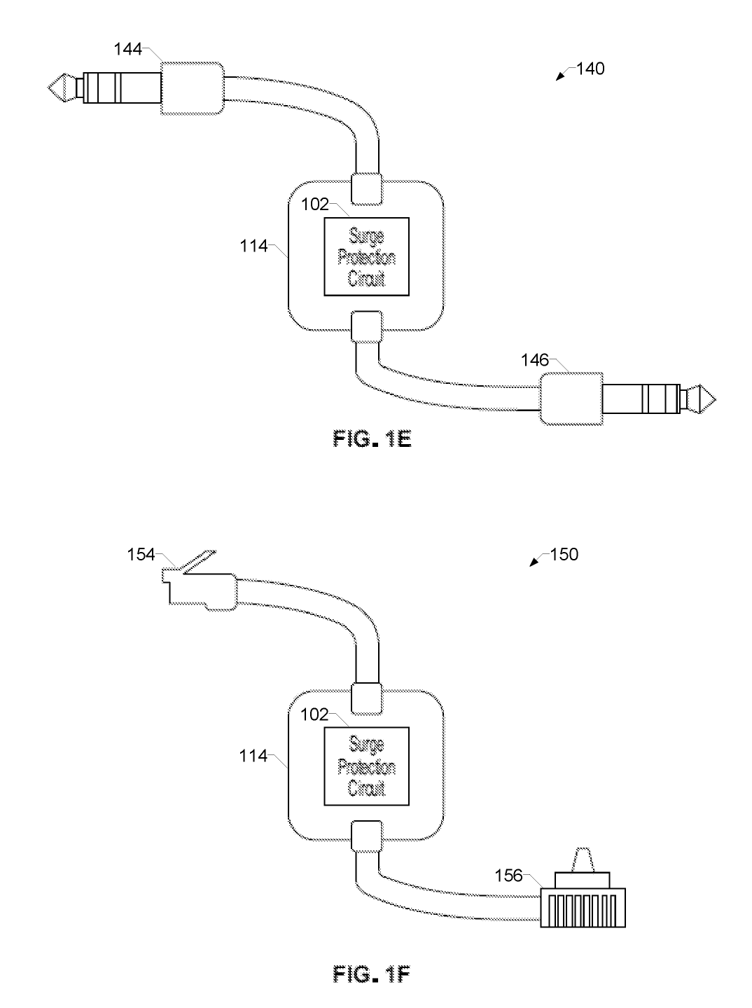

FIG. 1A illustrates an example three-conductor electrical power cord 100 including a surge protection circuit 102 integral with at least one plug 104, 106. The example electrical power cord 100 is a three-prong power cord (e.g., hot, neutral, and ground conductors) configured to operate with 115 VAC outlets in North America. However, the cord 100 and/or the plugs 104, 106 may be configured to use any other standard AC wall outlet connector type adopted by either the US or other country worldwide (e.g., Type C, Type D, Type E, Type G, Type H, etc.).

The plug 104 is configured for insertion into a three-prong 115 VAC outlet and the plug 106 is configured for connection to a device for receiving power (or, in some cases, delivering power). Each of the plugs 104, 106 includes an insulated housing. Either or both of the plugs 104, 106 in the example cord 100 may include a surge protection circuit 102 to provide surge protection.

FIG. 1B illustrates an example three-conductor electrical power cord 110 including a surge protection circuit 102 integral with a cable portion 112 of the electrical power cord 110. The type of the example electrical power cord 110, and the applicable standards and/or specifications, is similar to those of the cord 100 of FIG. 1A. FIG. 1C illustrates an example two-conductor electrical power cord 114 including a surge protection circuit integral with a cable portion of the electrical power cord. The cord 110 includes the plugs 104, 106, while the cord 112 includes two-prong plugs 118, 120.

In the examples of FIGS. 1B and 1C, the example cable portions 112 includes lengths of conductors and one or more layers of electrical insulation. The cable portion 112 may include filler material and/or other contents as appropriate to the cord 110.

The surge protection circuit 102 is integral with the cable portion 112 by physically securing a housing 116 of the surge protection circuit 102 to the cable 112. The housing 116 provides structural strength to the surge protection circuit 102. The conductors in the cable portion 112 may be hardwired to the surge protection circuit 102 within the housing 114. In some examples, the housing 116 provides strain relief to the cable portion 112 to increase the physical strength of the attachment of the housing 116 and the surge protection circuit 102 to the cable portion 112 of the cord 110.

In some other examples, the surge protection circuit 102 may omit the housing 114 and instead house the surge protection circuit within a layer of the electrical insulator surrounding the cable.

FIG. 1D illustrates an example AC-to-DC electrical power cord 130 including a surge protection circuit 102 integral with a cable portion of the electrical power cord. The example power cord 130 of FIG. 1D provides electrical surge protection to devices that use DC power input.

The example cord 130 includes an AC plug 132, an AC-to-DC adapter 134 to convert AC power to DC power, a DC plug 136, and the surge protection circuit 102. The example surge protection circuit 102 of FIG. 1D includes the housing 114, but may instead be housed within the cable. The AC-to-DC adapter 134 may be integral to the AC plug 132, included in the housing 114, and/or separately housed in-line with the cord 130.

FIG. 1E illustrates an example audio cord 140 including a surge protection circuit 102 integral with a cable portion 142 of the audio cord 140. FIG. 1F illustrates an example data cord 150 including a surge protection circuit 102 integral with a cable portion 152 of the data cord. The example audio cord 140 includes audio connectors 144, 146 to connect different audio component, and a corresponding number of conductors in the cable portion 142. Similarly, the data cord 150 includes data connectors 154, 156 to connect different communications devices. The audio connectors 144, 146 may be similar or dissimilar, and/or the data connectors 154, 156 may be similar or dissimilar.

The example surge protection circuits 102 of FIGS. 1E and 1F include the housing 114, but may instead be housed within the cable portions 142, 152. The example audio cord 140 and/or the example data cord 150 may be modified to surge protection to any cord configured to conduct analog and/or digital signaling.

Example audio connectors 144, 146 include ¼ inch audio jacks, 3.5 mm audio jacks, etc. Example data communication connectors include Universal Serial Bus (USB), twisted pair cabling systems (e.g., category 5 (CAT5) cables, category 5e (CAT5e) cables, category 6 (CAT6) cables, Ethernet cables, etc.), telephone cables, VGA, HDMI, SATA, coaxial, and/or any other type of data and/or power carrying cables.

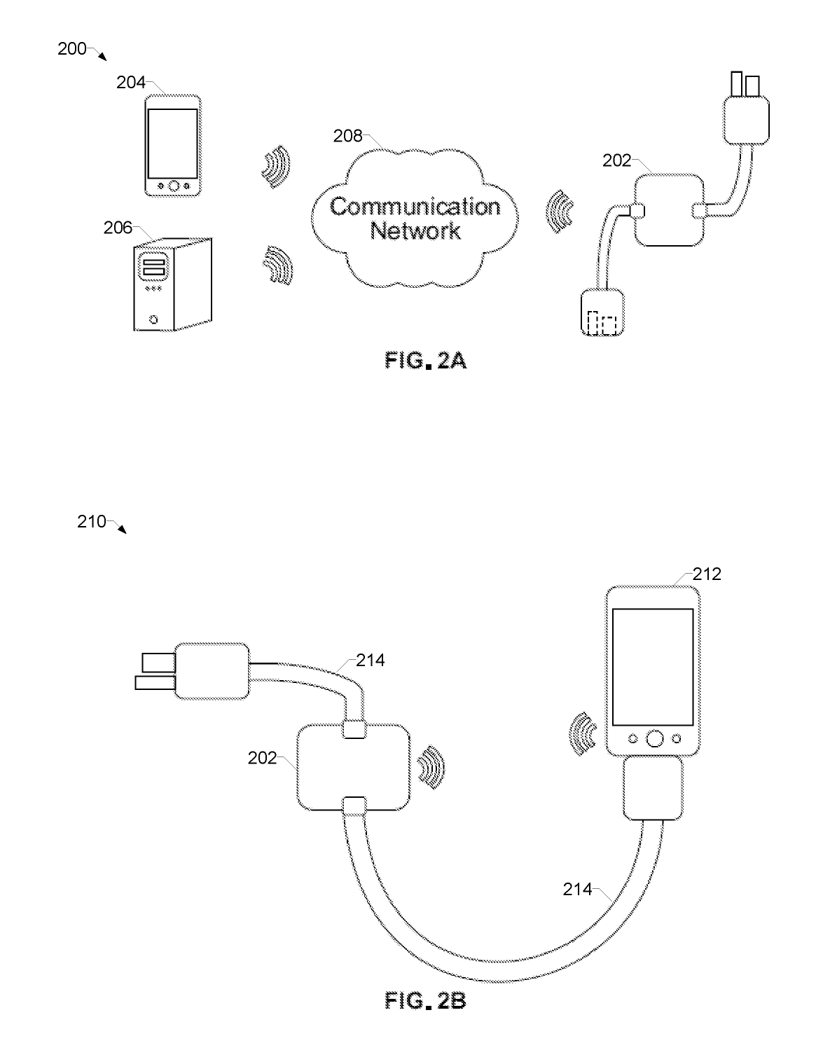

FIG. 2A illustrates an example system 200 for providing communications between a surge protection circuit 202 and an external device 204, 206 to provide alerts or other information. Example external devices 204, 206 may be any number of devices, systems, and/or sub-systems capable of receiving communications from the surge protection circuit 202 and providing a corresponding message or communication to a user. For example, the external devices 204, 206 may be mobile devices (e.g., smartphones or tablet computers), computing systems (e.g., laptops, personal computers, and/or servers), cloud-based systems, personal assistant devices (e.g., Amazon® Alexa-based devices, Apple® HomeKit®-compatible devices, etc.), and/or any other type of device. The example surge protection circuit 202 of FIG. 2A may communicate with one or more of the external devices 204, 206 via a communications network 208.

FIG. 2B illustrates an example system 210 for providing communications between a surge protection circuit 202 and an electronic device 212 being protected by the surge protection circuit 202 to provide alerts or other information. In the example of FIG. 2B, the surge protection circuit 202 communicates in a point-to-point manner, in contrast with the network-based communication methods of FIG. 2A. The point-to-point communications may occur wirelessly and/or through a cord 214 into which the surge protection circuit 202 is integrated.

Example communications may include alert messages regarding the protection status of the surge protection circuit 202. For example, when the energy diversion capacity of the surge protection circuit 202 decreases below a threshold energy, an alert is transmitted to provoke a notification to an owner or operator of the equipment protected by the surge protection circuit 202. The surge protection circuit 202 may be configured to send push notifications through a cloud based service to any designated devices when an electrical surge is detected.

The surge protection circuit 202 may include a transceiver configured to communicate via one or more wireless standards such as Bluetooth (e.g., short-wavelength, ultra-high frequency (UHF) radio waves in the industrial, scientific, and medical (ISM) band from 2.4 to 2.485 GHz), near-field communication (NFC), Wi-Fi (e.g., Institute of Electrical and Electronics Engineers' (IEEE) 802.11 standards), etc. For example, wireless connectivity (e.g., RF 900 MHz or Wi-Fi) may be built in to the surge protection circuit 202 to provide remote monitoring and control the electrical cable surge protector via one or more external communication devices, such as smartphones and/or tablets. As will be discussed below, the one or more external communication devices may provide an articulate and user-friendly interface to facilitate control of one or more surge protection circuits. That is, via a communication network, a user may monitor live status updates and/or historic data, remotely update software and/or firmware, and receive news, updates, and/or other information from the manufacturer or seller of the surge protector circuit. In some examples, an internal cellular modem may be implemented that utilizes standards-based wireless technologies, such as 2G, 3G, code division multiple access (CDMA),orthogonal frequency-division multiplexing (OFDM), and Global System for Mobile Communications (GSM), to provide wireless data communication over worldwide cellular networks. A electrical cable surge protector may be configured to communicate with devices similar to, but not limited to, cell phones, tablets, personal computers, servers, TVs, game consoles, monitors, etc. The electrical cable surge protector may also be configured to send notifications in response to determining, for example, that the surge protection circuit 202 is faulty, the cord is not compatible with a protected device, the surge protection circuit 202 has expired, and/or any other notifications.

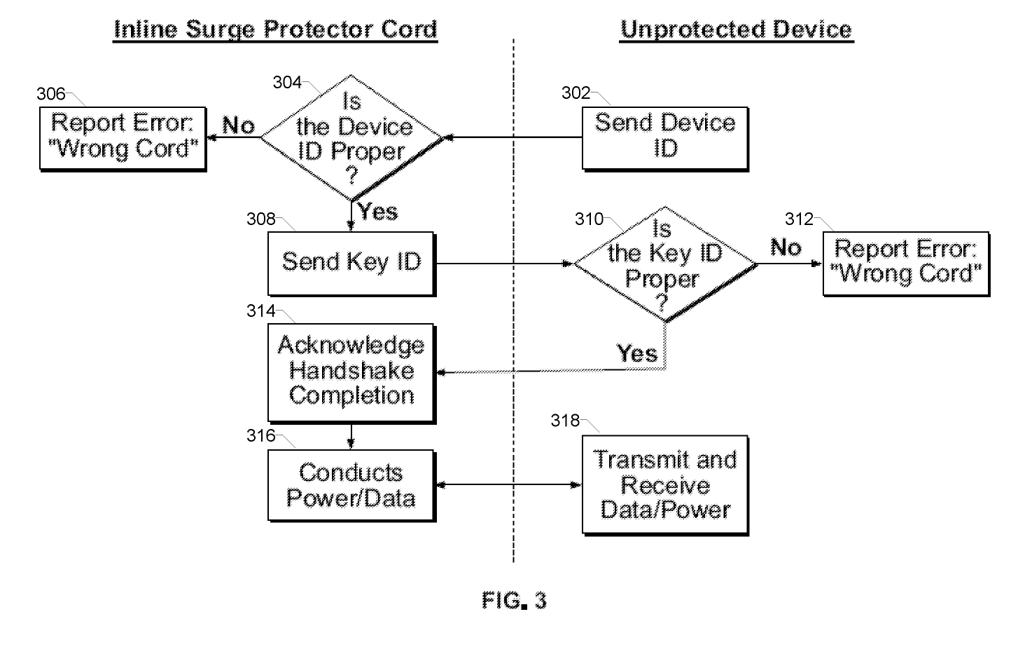

FIG. 3 is a flowchart representative of example machine readable instructions 300 which may be executed by the surge protector cord (e.g., the surge protector cord 210 of FIG. 2B) and an unprotected device (e.g., the device 212 of FIG. 2B) to execute a handshake protocol. As used with reference to FIG. 3, the unprotected device 212 does not include adequate self-protection from electrical surges, but may be protected by an external surge protection device such as the cord including the surge protection circuit 202.

The instructions 300 may be used by the surge protection circuit 202 to determine compatibility between the surge protection circuit 200 and the connected device 212. For example, when the device 212 is not provided with surge protection independently of the surge protection circuit 202 in the cord, the surge protection circuit 202 may be required to be included in the power cord used to power the connected device 212 by the manufacturer of the device 212. If the handshake protocol is not completed, the device 212 may be configured to indicate an error.

Communications are illustrated between the surge protection circuit 202 and the device 212. The surge protection circuit 202 and/or the device 212 may be configured to communicate wireles sly, and/or through a wired connection such as the cord to the connected device to verify whether the electrical cable surge protector and the connected device and compatible.

At block 302, the device 212 sends a device ID to the surge protection circuit 202. The device ID may be replaced with other handshake initiation data or challenge.

At block 304, the surge protection circuit 202 determines if the device ID is compatible. If the device ID is not compatible (block 304), at block 306 the surge protection circuit 202 identifies and/or reports an error. For example, an alert circuit may output and/or transmit a notification that the surge protection circuit 202 is not compatible with the currently connected device 212 to either, or both, the connected device 212 and/or another designated device.

If the surge protection circuit 202 determines that the device ID is compatible (block 304), at block 308 the surge protection circuit 202 sends a key ID to the device 212.

At block 310, the device 212 determines whether the surge protection circuit 202 is a compatible cable for use with the device 212. If the surge protection circuit 202 is not compatible (block 310), at block 312 the device 212 registers an error. For example, the surge protection circuit 202 and/or the device 212 may output or transmit a notification that the surge protection circuit 202 is not compatible with the currently connected device 212 to either, or both, the connected device 212 and/or another designated device.

If the key ID is determined to be correct for the device (block 310), at block 314 the surge protection circuit 202 acknowledges the handshake completion. At blocks 316 and 318, the cord conducts power and/or data to the device 212 while the device 212 transmits and/or receives data and/or power via the surge protection circuit 202.

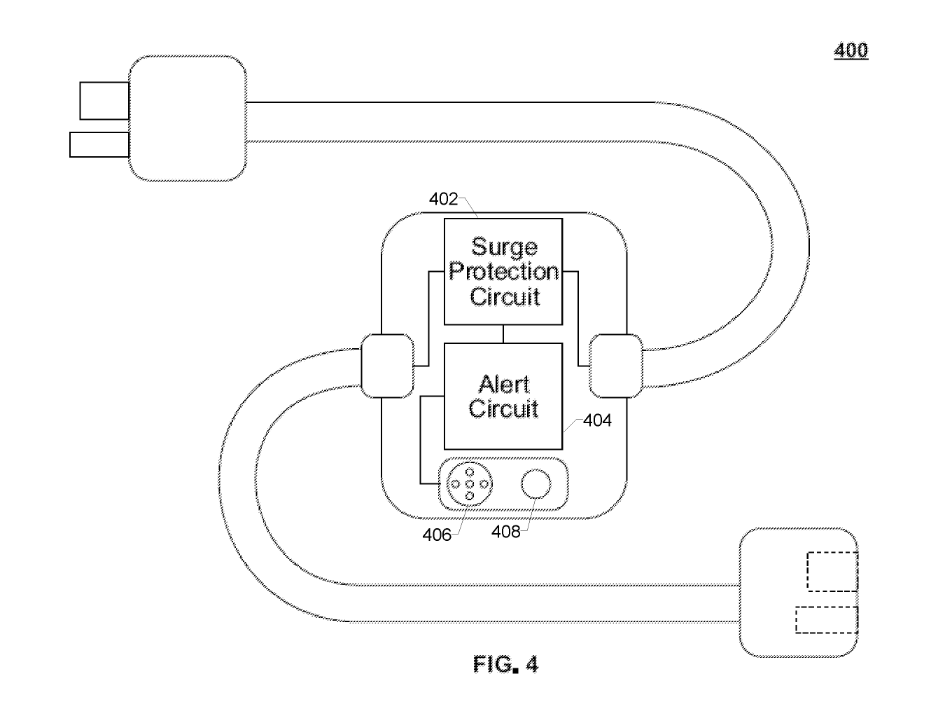

FIG. 4 illustrates an example electrical cord 400 with an integral surge protection circuit 402, an alert circuit 404, and auditory and/or visual indicators 406, 408. The example surge protection circuit 402, the alert circuit 404, and the auditory indicator 406 and/or the visual indicator 408 are enclosed in a housing 410 that is attached in line with a cable portion 412 of the cord 400.

In the example of FIG. 4, the alert circuit 404 outputs an alert when the surge protection circuit 402 experiences a peak or surge in energy (e.g., when a power surge is detected) and/or when an energy diversion capacity of the surge protection circuit 402 is less than a threshold (e.g., when the protective capabilities of the surge protection circuit are diminished).

The alert circuit 404 may include a visual alert circuit to drive the visual indicator 408 and/or an auditory circuit to drive the auditory indicator 406. For example, when the alert circuit 404 identifies an alert condition, the visual alert circuit may control the visual indicator 408 to emit light and/or the auditory alert circuit may control the auditory indicator 406 to emit a sound.

Additionally or alternatively, the alert circuit 404 may include a wireless and/or wired communication circuit to allow for communications with device(s) and outside network(s) to aid in notifications and handshake protocols (e.g., the protocol of FIG. 3 described above). The alert circuit 404 may receive instructions from a device or the network to control the surge protection circuit 402. For example, the alert circuit 404 may be remotely controlled to be enabled and/or disabled.

In some examples, the alert circuit 404 prevents power from being transferred to a connected device or network when the surge protection circuit 402 has a surge protection failure.

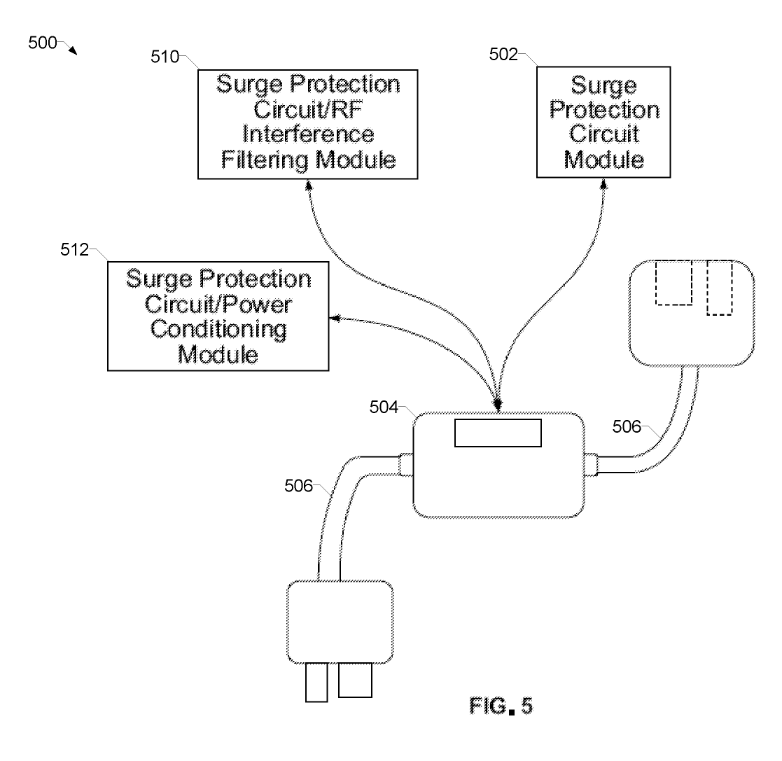

FIG. 5 illustrates an example electrical cord 500 with interchangeable and/or replaceable modules, which may include a surge protection circuit module 502. The example electrical cord 500 includes a housing 504 integrated in a cable portion 506 of the cord 500. The housing 504 may be opened to receive one or more modules for connection with the conductors in the cable portion 506. To this end, the housing 504 may include one or more connectors to which the modules may be connected to be electrically coupled to one or more of the conductors.

Example modules that may be added and/or removed from the housing 504 include the surge protection circuit module 502, a radio frequency (RF) interference filter module 510, and/or a power conditioning module 512. The RF interference filter module 510 may filter RF signals from the power or data signals being transmitted along the conductors in the cable 506. The power conditioning module 512 may filter noise and/or otherwise condition power being transmitted via the cable 506.

The modularity of the example cord 500 enables customization of the cable 500 and replacement of individual components of the cable 500.

Although the present disclosure relates to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. For example, systems, blocks, or other components of disclosed examples may be combined, divided, re-arranged, or otherwise modified. Therefore, the present disclosure is not limited to the particular implementations disclosed. Instead, the present disclosure will include all implementations falling within the scope of the appended claims, both literally and under the doctrine of equivalents.

1. An electrical cable surge protector, comprising:
an electrically insulated cable;
first and second plugs; and
a surge protection circuit electrically coupled to be integral with the power cable with the electrically insulated cable and configured to divert surge energy conducted between the first and second plugs by the electrically insulated cable.

2. The electrical cable surge protector of claim 1, wherein at least one of the first plug or the second plug comprises a ground terminal and two power transmission terminals configured to be plugged into an electrical outlet or an electrical appliance, the electrically insulated cable comprising a ground conductor coupled to the ground terminal and two electrical conductors coupled to the power transmission terminals.

3. The electrical cable surge protector of claim 1, further comprising an alert circuit configured to output an alert at least one of when the surge protection circuit experiences a peak or surge in energy, or when an energy diversion capacity of the surge protection circuit is less than a threshold.

4. The electrical cable surge protector of claim 3, wherein the alert circuit comprises at least one of a visual alert circuit or an auditory circuit.

5. The electrical cable surge protector of claim 4, wherein the visual alert circuit comprises at least one light source configured to emit light when the alert circuit is triggered.

6. The electrical cable surge protector of claim 4, wherein the auditory alert circuit comprises at least one speaker configured to emit sound when the alert circuit is triggered.

7. The electrical cable surge protector of claim 3, wherein the alert circuit is configured to transmit the alert to a device or network.

8. The electrical cable surge protector of claim 7, wherein the alert circuit is configured to execute a handshake protocol with the device or the network.

9. The electrical cable surge protector of claim 7, wherein the alert circuit is configured to prevent power from being transferred to a connected device or network when said surge protection circuit detects a surge protection failure.

10. The electrical cable surge protector of claim 7, wherein the alert circuit is configured to receive instructions from the device or the network to control the surge protection circuit.

11. The electrical cable surge protector of claim 10, wherein said alert circuit is configured to be remotely turned on or off from the device or network.

12. The electrical cable surge protector of claim 1, wherein the surge protection circuit is configured to be modularly attachable and integral with the electrically insulated cable and the first and second plugs to create a modular electrical cable surge protector.

13. The electrical cable surge protector of claim 12, further comprising a housing integral with the power cable and configured to comprise an additional modular attachment that is removable and electrically couples to the surge protection circuit integral with the power cable.

14. The electrical cable surge protector of claim 1, further comprising a second filter integral with the cable.

15. The electrical cable surge protector of claim 14, wherein the second filter integral with the cable is a RF interference filter.

16. The electrical cable surge protector of claim 14, wherein the second filter integral with the cable is a power conditioning filter.

17. The electrical cable surge protector of claim 13, wherein the additional modular attachment is configured to be a second filter integral with the cable.

18. The electrical cable surge protector of claim 13, wherein the additional modular attachment is configured to be a RF interference filter.

19. The electrical cable surge protector of claim 13, wherein the additional modular attachment is configured to be a RF interference filter and power conditioning filter.

20. The electrical cable surge protector of claim 1, wherein at least one of the first plug or the second plug comprises two power transmission terminals configured to be plugged into an electrical outlet or an electrical appliance, the electrically insulated cable comprising two electrical conductors coupled to the power transmission terminals.

21-24. (canceled)
